(19) United States
(12) Patent Application Publication
(10) Pub. No.: US 2017/0066488 A1
(43) Pub. Date: Mar. 9, 2017

(54) OVERTURN PREVENTION DEVICE FOR TRAILERS

(71) Applicant: Yasuhiro Egashira, Tokyo (JP)

(72) Inventor: Yasuhiro Egashira, Tokyo (JP)

(21) Appl. No.: 15/352,397

(22) Filed: Nov. 15, 2016

Related U.S. Application Data
(63) Continuation of application No. PCT/JP2016/060591, filed on Mar. 24, 2016.

(30) Foreign Application Priority Data
Apr. 9, 2015 (JP) 2015-089801

(51) Int. Cl. B62D 53/08; B60D 1/01

(52) U.S. Cl. CPC B62D 53/0871; B60D 1/015; B60Y 2200/148

(57) ABSTRACT

According to an embodiment, the width of the upper surface base of an uniaxial coupler (including the case where a biaxial type is used as uniaxial) normally installed in a tractor is formed to be extended in a lateral direction to an arbitrary length ranged from 1.5 times of the conventional coupler to substantially a full width of the vehicle.

### CROSS-REFERENCE TO RELATED APPLICATIONS

This application is a Continuation Application of PCT Application No. PCT/JP2016/060591, filed Mar. 24, 2016 and based upon and claiming the benefit of priority from prior Japanese Patent Application No. 2015-089801, filed Apr. 9, 2015, the entire contents of all of which are incorporated herein by reference.

### BACKGROUND OF THE INVENTION

1. Field of the Invention

The present invention relates to a device for preventing overturn of trailers, which operates based on overturn preventive measures derived from a trailer overturn theory established by the inventor.

2. Description of the Related Art

There are more overturn accidents of trailers occurring as compared to trucks. However, any overturn theory of how it occurs has not been reported on magazines of the society of automotive engineers, and actually it has not yet been solved. In the meantime, many drivers who had an accident in downhill curves of highways have testified to the police that the trailers overturned even though driving within the range of regulations of load and speed, and they did not understand why the accidents happened.

As described above, the overturn theory of trailers has been unsolved and therefore what measures should be taken is presently being discussed. Under these circumstances, trailer overturn preventive measures are one of the very important and serious subjects to be solved, which involve human lives.

### BRIEF SUMMARY OF THE INVENTION

The first object to be solved by the present invention is to investigate how overturn of a trailer occurs and find out its unsolved theory, and further establish measures therefor based on the theory. The second object is to provide a device which can make the carrying of a trailer as safe as the driving of a truck based on the following findings. That is, one of the very possible causes of trailer accidents resides in the loose coupling structure of the coupler between a tractor and a trailer, which allows a very slight rolling of the trailer. Because of this structure, the behavior of the trailer is not transmitted to the driver via the chassis of the trailer, which makes it unable for the driver to sense the behavior of the trailer and slow down by braking as in the case of a truck for safety. To avoid such danger, the second object is, specifically, to remodel the coupling structure into a trailer unrollable type for safety.

(1) According to one aspect of the invention, a trailer overturn prevention method and its device are characterized in that an upper base of a uniaxial coupler (including such a case where a biaxial type is used as a uniaxial) generally installed in a tractor is expanded laterally to an arbitrary length ranged from 1.5 times of the current original width to substantially a full width of the vehicle.

(2) According to another aspect of the invention, a trailer overturn prevention method and its device are characterized in that a rotating device which rotates substantially horizontally is provided under the position of the coupler installed in a tractor, and the coupler of the aspect (1) is installed on the rotating device.

### BRIEF DESCRIPTION OF THE SEVERAL VIEWS OF THE DRAWING

FIGS. 1A and 1B are plan and side views illustrating a trailer overturn theory, in which a turntable mounting a coupler is omitted.

FIGS. 2A, 2B, 2C and 2D are side views illustrating the overturn theory for truck sand trailers.

FIG. 3 is a perspective view of a coupler according to an embodiment of the present invention.

FIG. 4 is a cross-sectional view of a turntable of a uniaxial coupler taken along a broken line a-b shown in FIG. 3.

FIG. 5 is an exploded view of the embodiment.

### DETAILED DESCRIPTION OF THE INVENTION

### 1. Means for Achieving the Objects

After intensive studies, the inventor has established an overturn theory of trailers. The present invention is entirely based on this theory, and without understanding the theory, the advantageous effect of the present invention cannot be understood. Therefore, it will now be described in detail.

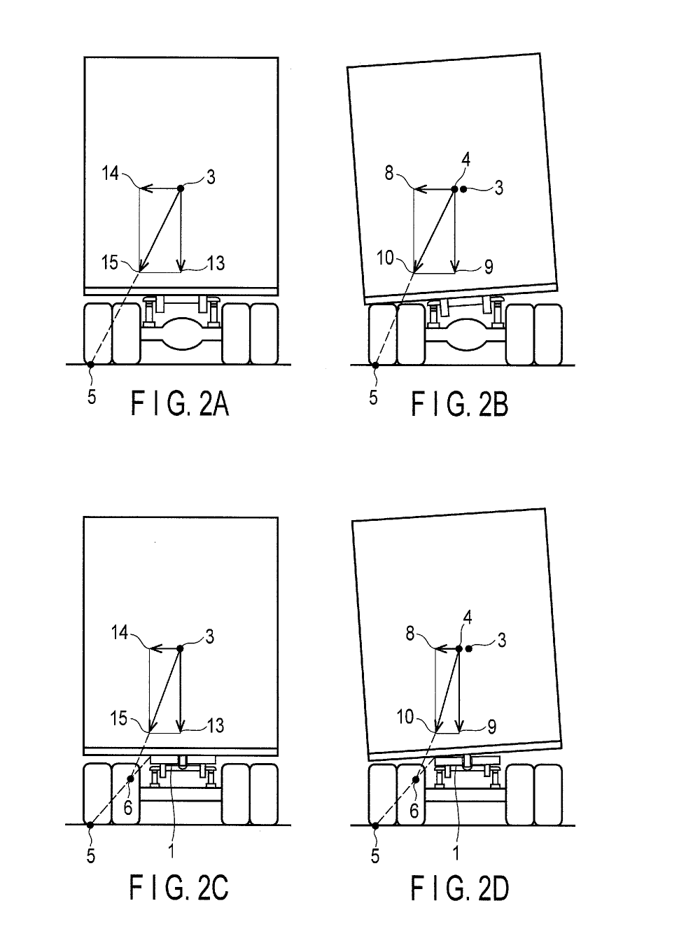

There may be various mathematical analyses of the overturn theory, and of these, the vector method is most simple to understand theoretically and illustratively. Further, this method can be easily applied for possibly actual measures to be taken. The theory will now be described with reference to FIG. 2. FIG. 2A is a side elevation seen from the back of a track, in which point 3 indicates a center of gravity of the total load weight m including the chassis, and an arrow from point 3 to 13 indicates, in the form of vector, a value mg obtained by multiplying the gravitational acceleration g by the total weight m. An arrow from point 3 to 14 indicates a centrifugal force mv²/r in vector. An arrow from point 3 to 15 indicates a synthetic vector of both of the aforementioned vectors. Note here that if the direction of the vector exceeds an edge end 5 of a wheel, the wheel overturns. In reality, the vehicle inclines because of the centrifugal force as shown in FIG. 2B, and thus the center of gravity 3 accordingly moves leftward to point 4. Thus, the vehicle begins to overturn on its side even by a weaker centrifugal force indicated by the vector of the arrow from point 4 to 8. The above-provided description is the theory for the ordinary trucks, which is the background knowledge of the present invention.

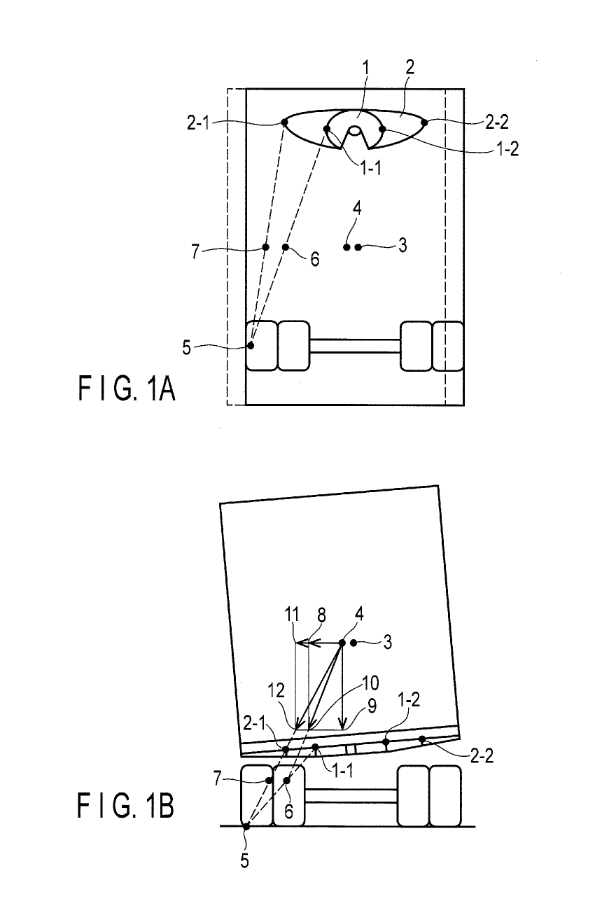

Next, the main subject, the overturn of a trailer will now be described with reference to FIG. 2C, which is a side elevation from the back of the trailer. Here, as in the case of the truck described above, if the synthetic vector of the centrifugal force and gravity indicated by the arrow from point 3 to 15 exceeds point 6, the trailer overturns. In reality, the center of gravity 3 is inclined outward by the centrifugal force and moves to point 4 as shown in FIG. 2D. As a result, the trailer overturns even by a weaker centrifugal force indicated by the arrow from point 4 to 8. This figure will be described in further detail with reference to FIG. 1.

FIG. 1A is a plan view of a trailer, and FIG. 1B is a rear view thereof. FIG. 1A shows a conventional coupler 1, which has a left end 1-1 thereof, and also a back trailer with wheels, one of which has an outer edge 5. The trailer is attached rotatably to a coupler of a tractor via a kingpin. The kingpin is made to have an allowance to some extent in its vertical direction since it is used for trailers of various heights. With this structure, it is analyzed that the trailer is rockingly rolled over by a centrifugal force around a dotted line connecting the end 1-1 of the coupler and the outer edge 5 of the rear-wheel tire, which is an important point to the theory. Point 6 is located on the dotted line in a direction in which the sum of the gravity 4 and the centrifugal force moves. That is, as shown in FIG. 1B, if the gravity center 3 moves to the position of point 4 by the centrifugal force and the synthetic vector from point 4 to 10 of the gravity vector from point 4 to 9 and the centrifugal force vector 4 to 8 exceeds point 6, the trailer begins to overturn. Once the trailer begins to overturn, the rotational energy of the overturn acts to rotate the wheels, resulting in the overturning of all the wheels. It should be noted here that in the case of a truck, it begins to turn over when the centrifugal force increases to the vector from point 4 to 11 as described in connection with FIG. 1B. Thus, it is understood that a trailer overturns by a centrifugal force smaller than that for a track.

Next, the overturn preventive measures for trailers will now be described based on the trailer overturn theory provided above. FIG. 1B shows the vector from point 4 to 8, which is the centrifugal force which can make the trailer to start overturning, whereas the vector from point 4 to 11 is the centrifugal force which can make the truck to start overturning. As can be understood from the illustration, no further improvement can be expected from this structure. Here, in order to improve the safety for the trailer as high as that of the truck, the end 1-1 of the coupler should be extended to 2-1. With this extended structure, the trailer is rockingly rolled over by a centrifugal force around a dotted line connecting point 5 to 2-1, as shown in FIG. 1A, to match the case of the truck. That is, the measures to be taken are to extend the width, defined between 1-1 and 1-2 of the conventional coupler, to a width defined between 2-1 and 2-2. With this structure, the safety of the trailer becomes as high as that of the truck. However, containers are not always loaded to have the center of gravity at a center of its stricture, but they are sometimes loaded extremely in an imbalanced way. Therefore, in order to further assure the safety, the width of the coupler should be further extended. Further, in consideration of, for example, the fixation of a trailer and a coupler when handling, the coupler should be extended to a full width of the vehicle.

In this manner, the loose coupling structure of the conventional type, which allows a very slight rolling of the trailer, can be improved and thus the second object of the invention is achieved. That it, with the present invention, the mechanism is improved as a rigid coupling structure, with which the rolling of a trailer is thoroughly transmitted to the tractor and therefore the driver becomes able to perceive the behavior of the trailer, which was not possible before, as in the case of driving a truck.

Moreover, since the trailers are made to have variable heights, the conventional coupler, which is the stationary type, is easily damaged while use. Here, the coupler must be converted into a revolving type. In other words, the extended coupler must be installed on a turntable.

### 2. Effects of Invention

There are mainly two kinds of effects of the present invention. First, the safety against the overturn of a trailer by centrifugal force can be improved to as high as that of driving a truck as compared to the conventional case. Second, a trailer and a tractor are rigidly coupled to each other in a rolling preventive fashion, and therefore the behavior of the trailer is transmitted to the chassis of the tractor, which is further transmitted to the driver's seat fixated to the chassis. Therefore, the driver is now able to perceive the behavior of the trailer, which was conventionally impossible, through the body, which enables him or her to slow down by braking early to be able to drive as safe as the case of a truck with confidence.

Next, the first effect, the improvement of the safety against the overturn of the trailer by the centrifugal force as high as the case of a truck as compared to the conventional case will now be described in detail.

Centrifugal force F is expressed by F =mv²/r, and therefore the ratio of speed is expressed by the square root of this value. In FIG. 1B, the vector from point 4 to 8 of the speed which makes the trailer to start overturning is 10 mm, whereas the vector from point 4 to 11 of the speed which makes the truck to start overturning is 13 mm. The square root of 10 is 3.16 and the square root of 13 is 3.60. Therefore, the overturn velocity ratio is 3.16 to 3.60, which means that when a track begins to overturn at 60 km/h, a trailer will begin to overturn at 52.2 km/h. This calculation may not be perfectly precise, but must be theoretically correct. Therefore, this value expresses an incident which is not far from the fact, and explains the reasons why trailers overturn so easily as testified to the police by the drivers who had trailer accidents. As described above, when the overturn preventive measures of the present invention are applied, it becomes possible to remarkably improve the safety against the overturn of trailers and secure the driving stability and safety as good as those of trucks.

### 3. Embodiment

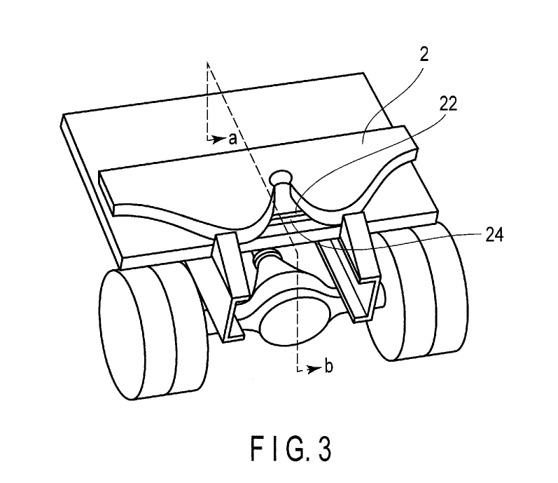

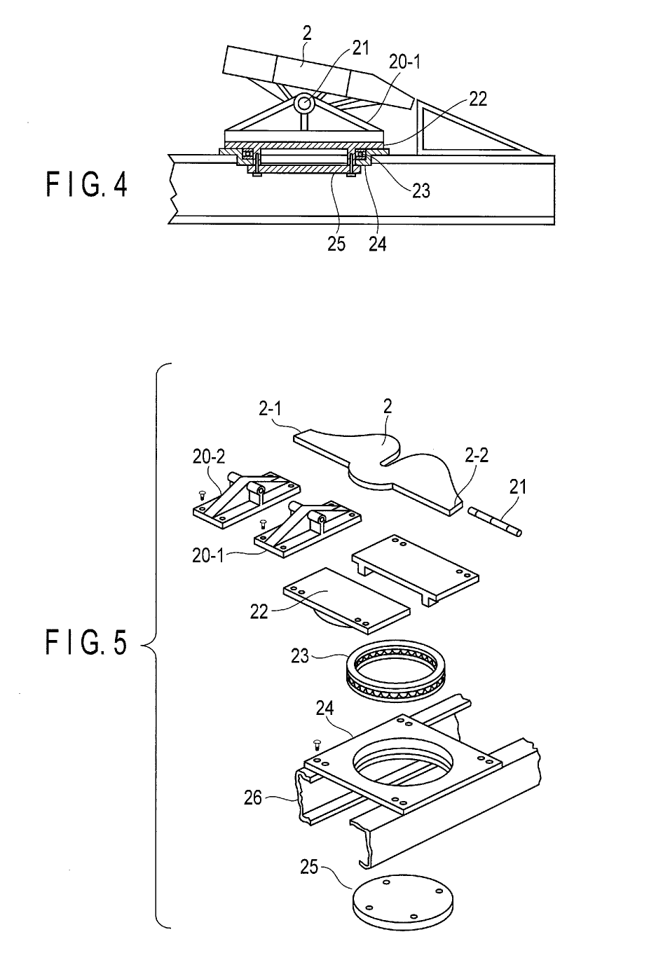

FIG. 3 is a perspective view of one embodiment of the present invention. The present invention is theoretically entirely novel, while, it is simple in terms of structure, in which the conventional coupler is extended in the lateral width and installed on a turntable. FIG. 4 is a partial cross section of the embodiment of the present invention, in which such a coupler is installed on a turntable, and FIG. 5 is an exploded view thereof. According to the device of the present invention, the contact face between the coupler and the chassis of the trailer, whose height may vary greatly from one model to another, are closely attached certainly to the coupler base of the present invention even when the trailer is running on a curve, and also the coupler is formed wide. With this structure, the rollover can be prevented as described before, and it becomes possible to drive a trailer as safety as a truck.

Note that the structure of the turntable is the same as the conventional one which is used for rotating parts of various cranes and the like, and therefore the explanation therefor is omitted.

### 4. Explanation of Reference Symbols

FIG. 4 shows an embodiment and FIG. 5 is an exploded view thereof showing an internal structure, which includes a coupler base 2, right and left ends 2-1 and 2-2 of the extended coupler base of the present invention, respectively, two suspension brackets 20-1 and 20-2 for a uniaxial coupler, a pitching shaft 21, a turntable 22, a thrust bearing 23, a turntable holder 24 firmly welded to the chassis 26, and a turntable support plate 25.

What is claimed is:

1. A trailer overturn prevention device comprising: a uniaxial coupler (including such a case where a biaxial type is used as a uniaxial) generally installed in a tractor, whose upper base is expanded laterally to an arbitrary length ranged from 1.5 times of the current original width to substantially a full width of the vehicle.
